(19) United States
(12) Patent Application Publication
(10) Pub. No.: US 2026/0309401 A1
(43) Pub. Date: Oct. 8, 2026

(54) SLIDING DOOR APPARATUS, DOOR BODY ASSEMBLY, AND REFRIGERATION DEVICE

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Zhanwei Liu, Hefei (CN); Jun Li, Hefei (CN); Huawei Zhang, Hefei (CN)

(21) Appl. No.: 19/161,240

(22) PCT Filed: Nov. 19, 2024
(86) PCT No.: PCT/CN2024/132875

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411187829.7

(51) Int. Cl. F25D 23/02; E05F 17/00

(52) U.S. Cl. CPC F25D 23/021; E05F 17/00; F25D 23/028; E05F 2017/005; E05Y 2201/654; E05Y 2201/684; E05Y 2201/708; E05Y 2900/31

(57) ABSTRACT

The present application relates to the field of home appliances and provides a sliding door apparatus, a door body assembly, and a refrigeration device. The sliding door apparatus comprises: a traction component; a driving sliding door component, which is arranged on an enclosure door and is in transmission connection with an enclosure body by means of the traction component; and a first driven sliding door component, the first driven sliding door component being arranged on the enclosure door, the first driven sliding door component being in transmission connection with the driving sliding door component, and the first driven sliding door component and/or the driving sliding door component being connected to a door panel. In the sliding door apparatus of the present application, the driving sliding door component is driven by means of the traction component, the first driven sliding door component is driven by the driving sliding door component, and the door panel is driven by means of the first driven sliding door component to move relative to the width direction of the enclosure door, so as to allow the door panel to avoid obstructions at either side. Also, when only the first driven sliding door component is connected to the door panel, the driving sliding door component does not directly bear the weight of the door panel, which prevents the driving sliding door component from bearing external forces in other directions.

### CROSS-REFERENCES TO RELATED APPLICATIONS

The present application claims priority to the Chinese patent application No. 202323218961.3, filed on Nov. 27, 2023, entitled “Refrigerator hinge”, the Chinese patent application No. 202410088590.1, filed on Jan. 22, 2024, entitled “Door Body Assembly and Refrigeration Device”, and the Chinese patent application No. 202411187829.7, filed on Aug. 26, 2024, entitled “Sliding Door Apparatus, Door Body Assembly, and Refrigeration Device”, all of which are incorporated herein by reference in their entireties.

FIELD

The present application relates to the field of household appliances, particularly to a slide door apparatus, a door body assembly, and a refrigeration equipment.

### BACKGROUND

With the increasing demand for the integration of household appliances and home furnishings, an embedded design of home appliances has become a trend.

However, to achieve a better integration effect between household appliances and home furnishings, it is sometimes necessary to install and connect a door panel on the surface of a box door. Meanwhile, the requirements of a relatively tight clearance between embedded appliances and cabinet sidewalls are relatively high to further improve the integration effect of household appliances and home furnishings. This leads to interference between the door body assembly with the door panel and the sidewall of the mounting space inside the cabinet during the process of opening and closing the door after the electrical appliances are built in the cabinet, if the traditional hinge is used, resulting in the door body assembly of the electrical appliance being unable to open or close normally.

### BRIEF SUMMARY

According to the present application, there is provided a slide door apparatus, a door body assembly, and a refrigeration equipment, to solve the problem of interference between the door body assembly with a door panel and the side of the mounting space during the process of opening and closing the door, which may result in the door body assembly of the electrical appliance being unable to open or close normally.

According to an embodiment of the present application, there is provided a slide door apparatus for a refrigeration equipment including a box body, a box door rotatably connected to the box body and configured to open or close a storage space of the box body, and a door panel slidably provided outside the box door,
in which the slide door apparatus includes:
a traction member;
a driving slide door member provided at the box door, where the driving slide door member is in transmission connection with the box body through the traction member; and p1 a first driven slide door member provided at the box door, where the first driven slide door member is in transmission connection with the driving slide door member, and at least one of the first driven slide door member or the driving slide door member is connected to the door panel,
in which during the process of opening or closing the box door, the box body drives the driving slide door member through the traction member, and the driving slide door member drives the first driven slide door member to drive the door panel to move in a width direction of the box door through the first driven slide door member matched with the driving slide door member.

According to an embodiment of the present application, the driving slide door member includes:
a first pedestal, in which a first side of the first pedestal is provided with a first guide rail and a second side of the first pedestal is provided with a second guide rail;
a first slider slidably provided at the first guide rail and connected to the box body through the traction member;
a second slider slidably provided at the second guide rail and in transmission connection with the first driven slide door member; and
a flexible cable, in which the two ends of the flexible cable are connected to the first slider and the second slider, respectively,
in which, in a case that the box body drives the first slider to move on the first guide rail through the traction member, the first slider drives the second slider to move on the second guide rail in an opposite direction through the flexible cable.

According to an embodiment of the present application, the flexible cable includes:
a first flexible cable, in which the first flexible cable bypasses a first end of the first pedestal and two ends of the first flexible cable are connected to a first end of the first slider and a first end of the second slider, respectively; and
a second flexible cable, in which the second flexible cable bypasses a second end of the first pedestal, and two ends of the second flexible cable are connected to a second end of the first slider and a second end of the second slider, respectively.

According to an embodiment of the present application, the first driven slide door member includes:
a second pedestal, in which an inner side of the second pedestal is connected to the second slider, an outer side of the second pedestal is connected to the door panel, and the second pedestal is provided with a third guide rail; and
a third slider slidably provided at the third guide rail and connected to the box door,
in which, in a case that the second slider moves on the second guide rail, the second slider drives the second pedestal to move relative to the third slider through the third guide rail.

According to an embodiment of the present application, the first driven slide door member further includes:
a first ball bearing support, in which the first ball bearing support is slidably connected to the third guide rail, and the third slider is slidably connected to the first ball bearing support.

According to an embodiment of the present application, the first ball bearing support includes:
a support frame provided between the third guide rail and the third slider and provided with a limit notch; and
a ball bearing rollably provided at the limit notch, in which a first side of the ball bearing abuts against the third guide rail, and a second side of the ball bearing passes through the limit notch and abuts against the third slider.

According to an embodiment of the present application, the third guide rail is provided with a limit member, and the limit member is located at two sides of the third slider respectively, in which, in a case that the third slider moves within the third guide rail, the movement range of the third slider is limited by a contact between the limit member and the third slider.

According to an embodiment of the present application, the first driven slide door member further includes:
a first hanger connected to the outer side of the second pedestal and configured to hang the door panel.

According to an embodiment of the present application, the first driven slide door member is provided with a fixation panel for connecting the door panel, and the driving slide door member is connected to the fixation panel to allow the first driven slide door member and the driving slide door member simultaneously drive the door panel to move in the width direction of the box door.

According to an embodiment of the present application, the first driven slide door member is provided with a fixation panel for connecting the door panel, and the driving slide door member is separated from the fixation panel to allow the driving slide door member indirectly drive the door panel to move in the width direction of the box door through the first driven slide door member.

According to an embodiment of the present application, there is provided a door body assembly including:
a box door rotatably connected to a box body and configured to open or close a storage space of the box body;
a door panel slidably provided at the outer side of the box door; and
the slide door apparatus described above provided at the box door.

According to an embodiment of the present application, the slide door apparatus is provided at a top end of the box door, and the door body assembly further includes: a second driven slide door member provided at a bottom end of the box door and connected to the door panel, in which, during the process of opening or closing the box door, the second driven slide door member is matched with the first driven slide door member to guide the door panel to move in the width direction of the box door.

According to an embodiment of the present application, the second driven slide door member includes:
a third pedestal provided with a fourth guide rail and connected to the door panel; and
a fourth slider slidably provided at the fourth guide rail and connected to the box door.

According to an embodiment of the present application, the second driven slide door member further includes:
a second hanger connected to an outer side of the third pedestal and configured to hang the door panel.

According to an embodiment of the present application, there is provided a refrigeration equipment including:
a box body provided with a storage space; and
the door body assembly described above rotatably connected to the box body and configured to open or close the storage space.

According to an embodiment of the present application, the box body is provided with at least two storage spaces, and a plurality of door body assemblies are provided, each door body assembly corresponding to one of the storage spaces, to drive the door panel to move relative to the corresponding box door during the process of opening or closing any of the box doors.

According to an embodiment of the present application, the box body is provided with a first storage space and a second storage space, and two door body assemblies are provided, namely a first door body assembly and a second door body assembly, in which the box door of the first door body assembly is rotatably connected to the box body, and configured to open or close the first storage space; and in which the box door of the second door body assembly is rotatably connected to the box body, and configured to open or close the second storage space.

The above one or more solutions in the embodiments of the present application have at least one of the following effects.

According to the present application, by providing a slide door apparatus which includes a traction member, a driving slide door member, and a first driven slide door member at a box door, the driving slide door member is in transmission connection with a box body through the traction member, and the first driven slide door member is in transmission connection with the driving slide door member, so that the box body drives the driving slide door member through the traction member, and the driving slide door member drives the first driven slide door member to drive a door panel to move in a width direction of the box door through the first driven slide door member. This allows the door panel to avoid obstacles on two sides, solving the problem of interference during door opening. Meanwhile, when only the first driven slide door member is used to connect the door panel, the driving slide door member does not directly withstand the weight of the door panel, which may prevent the driving slide door member from being subjected to external forces in other directions during the process of opening or closing the box door, and reduce the problem of the door panel swaying when moving relative to the box door.

According to the present application, the door panel may avoid obstacles on two sides during the process of opening and closing the box door. Meanwhile, the use of the first driven slide door member to support the door panel may prevent the driving slide door component from being subjected to external forces in other directions when driven, thereby reducing the problem of the door panel swaying when moving relative to the box door.

According to the embodiments of the present application, by the combination of the box door and the door panel, the refrigeration equipment may avoid interference with the door panel and surrounding objects during opening and closing, greatly improving user convenience. This design advantage is particularly evident in confined kitchen environments.

Additional aspects and advantages of the present application are set forth in part in the description which follows and, in part, are apparent from the description, or may be learned by practice of the present application.

### BRIEF DESCRIPTION OF THE DRAWINGS

To illustrate the solutions in the present application or the related art more clearly, the accompanying drawings used in the description of the embodiments of the present application or the related art will be briefly introduced below. It should be noted that the drawings in the following description are only some embodiments of the present application. For those of ordinary skill in the art, other drawings can also be obtained according to these drawings without any creative efforts.

FIG. 1 is a schematic structural diagram of a refrigeration equipment according to an embodiment of the present application.

FIG. 2 is an exploded schematic diagram of a refrigeration equipment according to an embodiment of the present application.

FIG. 3 is a schematic diagram of a slide door apparatus in a refrigeration equipment according to an embodiment of the present application.

FIG. 4 is a schematic diagram of a driving slide door member according to an embodiment of the present application.

FIG. 5 is a first schematic diagram of a first driven slide door member according to an embodiment of the present application.

FIG. 6 is a second schematic diagram of a first driven slide door member according to an embodiment of the present application.

FIG. 7 is a schematic diagram of a second driven slide door member according to an embodiment of the present application.

FIG. 8 is a schematic structural diagram of a door body assembly in a refrigeration equipment according to an embodiment of the present application when sliding.

FIG. 9 is a schematic structural diagram of the arrangement of a door body assembly in a refrigeration equipment according to an embodiment of the present application.

### REFERENCE SIGNS:

1: driving slide door member; 11: first slider; 12: second slider; 13: first pedestal; 131: first guide rail; 132: second guide rail; 14: flexible cable; 15: first fixation base; 16: second fixation base; 17: traction member; 18: second driven slide door member; 181: third pedestal; 1811: fourth guide rail; 182: fourth slider; 183: second hanger; 184: second ball bearing support; 2: box door; 21: first end cover; 22: second end cover; 3: door panel; 4: box body; 5: hinge; 6: first cabinet; 7: second cabinet; 8: mounting space; 9: first slide door member; 91: second pedestal; 911: third rail; 912: limit member; 92: third slider; 93: first ball bearing support; 94: first hanger; 95: fixation panel.

### DETAILED DESCRIPTION

Embodiments of the present application are further described in detail below with reference to the drawings and embodiments. The following embodiments are intended to illustrate the present application, but are not intended to limit the scope of the present application.

In the description of the embodiments of the present application, it should be noted that the orientation or positional relationships indicated by the terms such as “center,” “longitudinal,” “lateral,” “upper,” “lower,” “front,” “back,” “left,” “right,” “vertical,” “horizontal,” “top,”, “bottom,” “inside,” and “outside,” are based on the orientation or positional relationship shown in the drawings, and are merely for the convenience of describing the embodiments of the present application and simplifying the description, rather than indicating or implying that the device or component stated must have a particular orientation, or be constructed and operated in a particular orientation, and thus cannot be understood as limitation to the embodiments of the present application. Furthermore, the terms “first,” “second,” and “third” are only used for descriptive purposes and should not be construed as indicating or implying a relative importance.

In the description of embodiments of the present application, it should be noted that, unless otherwise explicitly specified and defined, the terms “connected to” and “connected” shall be understood broadly. For example, it may refer to a fixed connection, a detachable connection, or an integrated connection. It may refer to a mechanical connection or an electric connection, or it may refer to a direct connection or an indirect connection through an intermediate medium. The specific meanings of the terms above in embodiments of the present application may be understood by those skilled in the art in accordance with specific circumstances.

In the embodiments of the present application, unless otherwise clearly stated and defined, the first feature being located “on” or “under” the second feature may mean that the first feature is in direct contact with the second feature or the first feature is in indirect contact with the second feature by an intermediate medium. In addition, the first feature being “on”, “above,” and “over” the second feature may refer to that the first feature is directly above or obliquely above the second feature, or simply refer to that the level of the first feature is higher than that of the second feature. The first feature being “under,” “below,” and “beneath” the second feature may refer to that the first feature is directly below or obliquely below the second feature, or simply refer to that the level of the first feature is lower than that of the second feature.

In the description of the present specification, the description with reference to the terms “one embodiment,” “some embodiments,” “an example,” “specific example,” “some examples” and the like, refers to that specific features, structures, materials or characteristics described in combination with an embodiment or an example are included in at least one embodiment or example of the embodiments of the present application. In the present specification, the schematic expressions of the above terms are not necessarily directed to the same embodiment or example. Furthermore, the particular features, structures, materials, or characteristics described may be combined in any suitable manner in any one or more embodiments or examples. In addition, those skilled in the art may combine different embodiments or examples described in this specification, as well as the features of different embodiments or examples, without conflicting with each other.

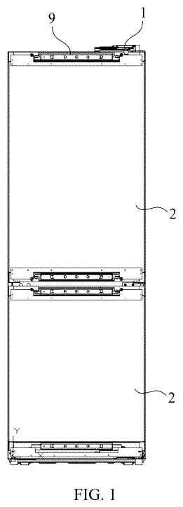

A slide door apparatus, a door body assembly, and a refrigeration equipment according to the present application will be described below in conjunction with FIG. 1 to FIG. 9. The slide door apparatus and door body assembly according to the present application can be applied to a box door or a cabinet door of household appliances, such as a box door of a refrigerator. However, it should be understood that the door body assembly according to the present application can also be applied to any other suitable device. The refrigeration equipment according to the present application is applied to for example, as a refrigerator, but it should be understood that the refrigeration equipment according to the present application can also be applied to a freezer or any other suitable equipment.

In an embodiment of the present application, as shown in FIG. 1 to FIG. 3, the slide door apparatus is applied to a refrigeration equipment, which includes a box body 4, a box door 2 rotatably connected to the box body 4 and configured to open or close a storage space of the box body 4, and a door panel 3 slidably provided outside the box door 2.

In this embodiment, the slide door apparatus includes a traction member 17, a driving slide door member 1, and a first driven slide door member 9. The driving slide door member 1 is provided at the box door 2, and is in transmission connection with the box body 4 through the traction member 17. The first driven slide door member 9 is provided at the box door 2, and is in transmission connection with the driving slide door member 1. At least one of the first driven slide door member 9 or the driving slide door member 1 is connected to the door panel 3. During the process of opening or closing the box door 2, the box body 4 drives the driving slide door member 1 through the traction member 17, and the driving slide door member 1 drives the first driven slide door member 9 to drive the door panel 3 to move in a width direction of the box door 2 through the first driven slide door member matched with the driving slide door member 1.

In this embodiment, the box body 4 serves as the main body of the refrigeration equipment. The box body 4 is provided with a storage space inside for storing food or other items requiring refrigeration or freezing. The box door 2 is mounted on the box body 4 through a certain rotational connection (such as hinge 5), which can rotate around one or more axis points to open and close the storage space. The door panel 3 is an additional, sliding member provided at the outside of the box door 2.

In this embodiment, the traction member 17 (such as a chain, a belt, or a wire rope) is connected to the box body 4 and the driving slide door member 1. When the box door 2 is opened or closed, power is transmitted to the driving slide door member 1 through the movement of the traction member 17. The driving slide door member 1 does not directly withstand the weight of the door panel 3, but serves as the key to transmission power, converting the power from the traction member 17 into driving the first driven slide door member 9. The first driven slide door member 9 closely is matched with the driving slide door member 1, directly connecting and driving the door panel 3 to move.

In a case where only the first driven slide door member 9 is connected to the door panel 3, since the first driven slide door member 9 withstands the weight of the entire door panel 3, the design of the first driven slide door member 9 needs to balance strength and flexibility to ensure smooth sliding of the door panel 3. During the process of opening or closing the box door 2, the box body 4 drives the driving slide door member 1 through the traction member 17. The driving slide door member 1 drives the first driven slide door member 9 to drive the door panel 3 to move in a width direction of the box door 2 through the first driven slide door member 9, thereby avoiding interference with the door panel 3 and external obstacles. During this process, the driving slide door member 1, which directly withstands the driving force, does not withstand the weight of the door panel 3, while the first driven slide door member 9 connected to the door panel 3 withstands the weight of the entire door panel 3. This prevents the driving slide door member 1 from being subjected to external forces in other directions during the process of opening or closing the box door 2, and reduces the problem of the door panel 3 swaying when moving relative to the box door 2.

In a case where both the first driven slide door member 9 and the driving slide door member 1 are connected to the door panel 3, the weight of the door panel 3 is jointly withstood by the first driven slide door member 9 and the driving slide door member 1, which reduces the weight withstood by the driving slide door member 1 and reduces the problem of the door panel 3 swaying when moving relative to the box door 2 to a certain extent. Meanwhile, due to the connection between the driving slide door member 1 and the door panel 3, the sensitivity of the entire slide door apparatus can be improved.

In a case where only the driving slide door member 1 is connected to the door panel 3, the weight of the door panel 3 is withstood by the driving slide door member 1, which allows the driving slide door member 1 to drive the door panel 3 to move.

According to the embodiment, by providing a slide door apparatus which includes a traction member 17, a driving slide door member 1, and a first driven slide door member 9 at a box door 2, the driving slide door member 1 is in transmission connection with a box body 4 through the traction member 17, and the first driven slide door member 9 is in transmission connection with the driving slide door member 1, so that the box body 4 drives the driving slide door member 1 through the traction member 17, and the driving slide door member 1 drives the first driven slide door member 9 to drive a door panel 3 to move in a width direction of the box door 2 through the first driven slide door member 9. This allows the door panel 3 to avoid obstacles on two sides, solving the problem of interference during door opening. Meanwhile, when only the first driven slide door member 9 is used to connect the door panel 3, the driving slide door member 1 does not directly withstand the weight of the door panel 3, which may prevent the driving slide door member 1 from being subjected to external forces in other directions during the process of opening or closing the box door 2, and reduce the problem of the door panel 3 swaying when moving relative to the box door 2.

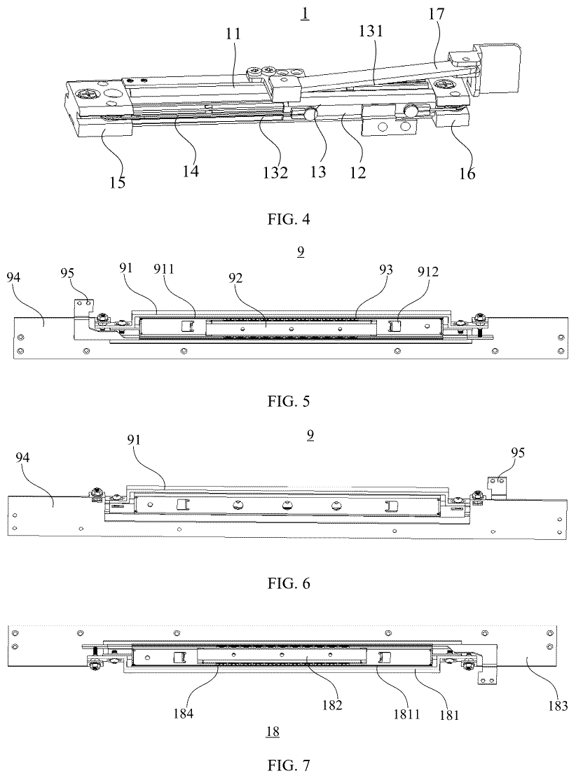

In some embodiments, as shown in FIG. 4, the driving slide door member 1 includes a first pedestal 13, a first slider 11, a second slider 12, and a flexible cable 14. A first side of the first pedestal 13 is provided with a first guide rail 131, and a second side of the first pedestal 13 is provided with a second guide rail 132. The first slider 11 is slidably provided at the first guide rail 131 and connected to the box body 4 through the traction member 17. The second slider 12 is slidably provided at the second guide rail 132 and is in transmission connection with the first driven slide door member 9. The two ends of the flexible cable 14 are connected to the first slider 11 and the second slider 12, respectively. In a case where the box body 4 drives the first slider 11 to move on the first guide rail 131 through the traction member 17, the first slider 11 drives the second slider 12 to move on the second guide rail 132 in an opposite direction through the flexible cable 14.

In this embodiment, the first pedestal 13 is fixed to the box door 2. The inner and outer sides of the first pedestal 13 are provided with the first guide rail 131 and the second guide rail 132, respectively. The first guide rail 131 and the second guide rail 132 provide tracks for the sliding of the first slider 11 and the second slider 12, respectively. The first slider 11 is slidably provided at the first guide rail 131, connected to the box body 4 through the traction member 17, and driven by the box body 4 to move on the first guide rail 131. The second slider 12 is also slidably provided at the second guide rail 132, but connected to the first driven slide door member 9 for driving the first driven slide door member 9. The flexible cable 14 can be a connection component, such as a traction rope or a transmission belt, and the like. The two ends of the flexible cable 14 are connected to the first slider 11 and the second slider 12, respectively, so that the first slider 11 can drive the second slider 12 to move synchronously and move in opposite directions. This design ensures that during the sliding process of the door panel 3 in the width direction of the box body 4, both the first slider 11 and the second slider 12 only withstand the driving force of the traction member 17, and do not need to withstand the weight of the door panel 3 in the vertical direction. The weight of the entire door panel 3 is supported only by the first driven slide door component 9, which reduces the problem of the door panel 3 swaying when moving relative to the box door 2.

During the process of rotating and opening the box door 2 towards the outside of the box body 4, the box body 4 drives the first slider 11 to slide in a direction close to the hinge 5 through the traction member 17. Meanwhile, the first slider 11 drives the second slider 12 to slide in an opposite direction through the flexible cable 14. The second slider 12 drives the first driven slide door member 9, which in turn drives the door panel 3 to move, thereby avoiding interference between the door panel 3 and external obstacles. During the process of rotating and closing the box door 2 towards the side of the box body 4, the box body 4 drives the first slider 11 to slide in a direction away from the hinge 5 through the traction member 17. Meanwhile, the first slider 11 drives the second slider 12 to slide in an opposite direction through the flexible cable 14. The second slider 12 drives the first driven slide door member 9, which in turn drives the door panel 3 to move, thereby avoiding interference between the door panel 3 and obstacles after closing.

In some embodiments, as shown in FIG. 4, the flexible cable 14 includes a first flexible cable and a second flexible cable. The first flexible cable bypasses a first end of the first pedestal 13, and two ends of the first flexible cable are connected to a first end of the first slider 11 and a first end of the second slider 12, respectively. The second flexible cable bypasses a second end of the first pedestal 13, and two ends of the second flexible cable are connected to a second end of the first slider 11 and a second end of the second slider 12, respectively.

In this embodiment, the first flexible cable bypasses the first end of the first pedestal 13, and two ends of the first flexible cable are connected to the first slider 11 and the second slider 12, respectively. When the first slider 11 slides in a direction away from the first end of the first pedestal 13 under the drive of the box body 4, the first slider 11 drives the second slider 12 to slide in a direction closer to the first end of the first pedestal 13 through the first flexible cable. Meanwhile, the second flexible cable bypasses the second end of the first pedestal 13, and the two ends of the second flexible cable are connected to the first slider 11 and the second slider 12, respectively. When the first slider 11 slides in a direction away from the second end of the first pedestal 13 under the drive of the box door 2, the first slider 11 drives the second slider 12 to slide in a direction closer to the second end of the first pedestal 13 through the second flexible cable. This ensures that when the first slider 11 slides towards the two ends of the first pedestal 13, respectively, it can drive the second slider 12 to slide in an opposite direction to the first slider 11, and then cooperate with the first driven slide door member 9 to enable the door panel 3 to slide relative to the box door 2 with the rotation of the box door 2 when the box door 2 is opened or closed, so as to avoid interference with obstacles and affect the opening and closing of the box door 2.

In some embodiments, as shown in FIG. 4, the driving slide door member 1 further includes a first fixation base 15 and a second fixation base 16. The first fixation base 15 is connected to the first end of the first pedestal 13, and is provided with a first limit slot. The two ends of the first limit slot are connected to the first end of the first guide rail 131 and the first end of the second guide rail 132. A portion of the first flexible cable is slidably provided at the first limit slot. The second fixation base 16 is connected to the second end of the first pedestal 13, and is provided with a second limit slot. The two ends of the second limit slot are connected to the second end of the first guide rail 131 and the second end of the second guide rail 132. A portion of the second flexible cable is slidably provided at the second limit slot.

In an embodiment, the first fixation base 15 is connected to the first end of the first pedestal 13, serving as an extension and support for the first guide rail 131 and the second guide rail 132 at that end. The first fixation base 15 is provided with a first limit slot, which not only provides an additional sliding track for the first flexible cable but also ensures the stability and accuracy of the first flexible cable during the sliding process. The two ends of the first limit slot are connected to the first end of the first guide rail 131 and the first end of the second guide rail 132. The presence of the first limit slot restricts the deviation and swaying of the first flexible cable during the sliding process, improving the operational accuracy and reliability of the entire driving slide door member 1. The second fixation base 16 corresponds to the first fixation base 15, and is connected to the second end of the first pedestal 13, providing support and extension for the first guide rail 131 and the second guide rail 132 at that end. The second fixation base 16 is provided with a second limit slot. The design of the second limit slot is similar to that of the first limit slot, but the second limit slot is located at the second end of the driving slide door member 1. The two ends of the second limit slot are connected to the second end of the first guide rail 131 and the second end of the second guide rail 132, providing guidance and limiting for the sliding of the second flexible cable. The second limit slot is the same as the first limit slot, and it also serves to restrict the deviation and swaying of the flexible cable 14.

To ensure the mounting of a driving sliding mechanism, in some embodiments, as shown in FIG. 4, at least one of the first fixation base 15 or the second fixation base 16 is provided with a fixation hole. The driving slide door member 1 further includes a fixation member, which passes through the fixation hole to be connected to the box door 2, so as to fix the entire driving slide door member 1 on the box door 2.

In this embodiment, at least one of the first fixation base 15 or the second fixation base 16 connected to the first pedestal 13 is fixed to the box door 2 by a fixation member, which can ensure that the mechanism does not loosen or shift due to external forces or vibrations during operation. The design of the fixation hole and the fixation member makes the mounting process simple and fast. The operator only needs to align the fixation member with the fixation hole and tighten it to complete the connection between the driving slide door member 1 and the box door 2. When it is necessary to repair or replace the driving slide door member 1, the driving slide door member 1 can be removed from the box door 2 by simply removing the fixation member without the need for complex disassembly work. This greatly improves the maintainability and flexibility of the equipment.

In a specific implementation, a suitable fixation member, such as a screw, a bolt, a rivet, and the like, can be selected according to the structure and material of box door 2. Meanwhile, it is necessary to ensure that the position and size of the fixation hole match the fixation member to ensure the firmness and stability of the connection.

In some embodiments, as shown in FIG. 4, FIG. 5, and FIG. 6, the first driven slide door member 9 is of a C-shaped drawer track structure, including a second pedestal 91 and a third slider 92. The inner side of the second pedestal 91 is connected to the second slider 12 through a fixation panel 95, and the outer side of the second pedestal 91 is connected to the door panel 3. The second pedestal 91 is provided with a third guide rail 911 inside. The third slider 92 is slidably provided at the third guide rail 911, and is connected to the box door 2. In a case where the second slider 12 moves on the second guide rail 132, the second slider 12 drives the second pedestal 91 to move relative to the third slider 92 through the third guide rail 911.

In this embodiment, the inner side of the second pedestal 91 is connected to the second slider 12, and the second pedestal 91 moves along with the movement of the second slider 12 on the second guide rail 132. Meanwhile, the outer side of the second pedestal 91 is directly connected to the door panel 3, so that when the second pedestal 91 moves, it can drive the door panel 3 to move together. The second pedestal 91 is designed with a third guide rail 911 inside for accommodating and guiding the sliding of the third slider 92. The third slider 92 not only interacts with the third guide rail 911 to achieve sliding function, but it is also connected to the box door 2 (or possibly a part of the box door). This means that when the third slider 92 moves on the third guide rail 911, the door panel 3 and the box door 2 move relative to each other through the relative movement between the second pedestal 91 and the third slider 92.

When the second slider 12 moves along the second guide rail 132, the second pedestal 91 also moves because the inner side of the second pedestal 91 is connected to the second slider 12. During this process, the third slider 92 is fixed on the box door 2 and is slidably provided at the third guide rail 911 of the second pedestal 91. Therefore, when the second pedestal 91 moves, it drives the door panel 3 to move accordingly through the relative movement between the third guide rail 911 and the third slider 92.

In some embodiments, as shown in FIG. 4 to FIG. 6, the first driven slide door member 9 further includes a first ball bearing support. The first ball bearing support 93 is slidably connected to the third guide rail 911, and the third slider 92 is slidably connected to the first ball bearing support 93. When the second slider 12 moves on the second guide rail 132, it may drive the second pedestal 91 to move through a connection member (such as a rod, a chain, and the like) or through a direct way. As the second pedestal 91 moves, the third slider 92 moves relative to it. At this time, the third slider 92 slides with low friction and high efficiency in the third guide rail 911 with the assistance of the first ball bearing support 93. Due to the presence of the first ball bearing support 93, the sliding process of the third slider 92 becomes smoother and more reliable, ensuring the stable operation of the entire first driven slide door member 9.

In an embodiment, the first ball bearing support 93 includes a support frame and ball bearing (not shown). The support frame is provided between the third guide rail 911 and the third slider 92. The support frame is provided with a limit notch. The ball is rollably provided at the limit notch. A first side of the ball bearing abuts against the third guide rail 911, and a second side of the ball bearing passes through the limit notch and abuts against the third slider 92.

In this embodiment, the support frame is provided between the third guide rail 911 and the third slider 92. It is used to ensure that the ball bearing to roll in the correct position, thereby supporting the sliding of the third slider 92. The support frame is provided with a limit notch, which is used to accommodate the ball bearing and limit their rolling range. The limit notch ensures that the ball bearing not detach from the support frame during rolling, and also provides a certain rolling space for the ball bearing. The ball bearing is provided at the limit notch. The first side of the ball bearing abuts against the third guide rail 911, and the second side of the ball bearing passes through the limit notch and abuts against the third slider 92. This design allows the third slider 92 to no longer directly contact the third guide rail 911 and generate sliding friction during sliding, but to slide through the rolling of ball bearing. This approach greatly reduces the frictional resistance during sliding and improves the sliding efficiency. Due to the low friction of ball bearing rolling, it can significantly reduce the wear between the third slider 92 and the third guide rail 911. This helps to prolong the service life of these two members and reduces maintenance costs.

When the third slider 92 needs to slide along the third guide rail 911, the second pedestal 91 is subjected to external driving force (such as the driving force from the second slider 12). During this process, the second pedestal 91 pushes the ball bearing to roll in the limit notch of the support frame. The first side of the ball bearing is in contact with the third guide rail 911 and rolls, while the second side of the ball bearing is in contact with the third slider 92 and rolls. In this way, the first ball bearing support 93 provides stable and efficient support for the sliding of the third slider 92.

In summary, the first ball bearing support 93 in this embodiment provides effective support and assistance for the sliding of the third slider 92 in the third guide rail 911 through the combined design of the support frame and bearing, thereby effectively improving the sliding efficiency.

In addition, as shown in FIG. 5 and FIG. 6, the third guide rail 911 is provided with a limit member 912, and the limit member 912 is located at two sides of the third slider 92 respectively. In a case where the third slider 92 moves within the third guide rail 911, the movement range of the third slider 92 is limited by a contact between the limit member 912 and the third slider 92. The limit member 912 should be precisely mounted at the appropriate position on the third guide rail 911 to ensure that they may effectively restrict the movement range of the third slider 92. The general position of the limit member 912 is determined based on the movement requirements of the door panel 3 and the box door 2. The shape and size of the limit member 912 should be determined based on the contour and movement of the third slider 92, to withstand the impact force generated by the third slider 92 upon contact and maintain a stable limiting effect.

In operation, when the third slider 92 moves within the third guide rail 911, the second pedestal 91 slides according to the external driving force (such as the driving force from the second slider 12). During this process, if the relative position between the third slider 92 and the second pedestal 91 attempts to exceed the predetermined range of movement, the third slider 92 comes into contact with a limit member 912 on either side. Upon contact, the limit member 912 prevents further movement of the third slider 92 and the second pedestal 91, thereby confining them to the predetermined range.

In an embodiment, as shown in FIG. 1 to FIG. 6, to facilitate the mounting of the door panel 3, the first driven slide door member 9 further includes a first hanger 94. The first hanger 94 is connected to the outer side of the second pedestal 91 and configured to hang the door panel 3.

In this embodiment, the first hanger 94 serves as a hanging point for the door panel 3, making the mounting of the door panel 3 simpler and faster. Installers only need to hang the door panel 3 to the first hanger 94, without the need for complex fixation or connecting operations. The first hanger 94 is provided with a connection structure that matches the outer side of the second pedestal 91, to ensure a firm connection to the second pedestal 91. This connection structure may be a bolted connection, welded connection, or other reliable connections. Meanwhile, the first hanger 94 is provided with a hanging point suitable for hanging the door panel 3, to withstand the weight of the door panel 3 and the force generated during the sliding process.

During the mounting process, installers first firmly connect the first hanger 94 to the outside of the second pedestal 91. Then, they hang or connect the corresponding part of door panel 3 to the first hanger 94. Due to the firm connection between the first hanger 94 and the second pedestal 91, the door panel 3 also maintains a stable connection state through the first hanger 94 and the second pedestal 91.

In some embodiments, as shown in FIG. 1 to FIG. 5, the first driven slide door member 9 is provided with a fixation panel 95 for connecting the door panel 3. The driving slide door member 1 is connected to the fixation panel 95, that is, the first driven slide door member 9 and the driving slide door member 1 simultaneously support the door panel 3 through the fixation panel 95. At this time, the first driven slide door member 9 and the driving slide door member 1 simultaneously drive the door panel 3 to move in the width direction of the box door 2.

Due to the weight of door panel 3 being jointly withstood by the first driven slide door member 9 and the driving slide door member 1, the weight withstood by the driving slide door member 1 is reduced, which to some extent reduces the swaying of door panel 3 when moving relative to the box door 2. Meanwhile, due to the connection between the driving slide door member 1 and the door panel 3, the sensitivity of the entire slide door apparatus can be increased.

In this embodiment, the weight of the door panel 3 is shared by two slide door members, which reduces the weight withstood by the driving slide door member 1 alone and helps to prolong its service life.

Due to the dispersion of gravity, the swaying of the door panel 3 during movement is also reduced correspondingly, improving the stability and reliability of the slide door apparatus. In addition, since the driving slide door member 1 is directly connected to the door panel 3, it can sense the movement requirements of the door panel 3 more directly, thereby making a response more quickly and increasing the sensitivity of the entire slide door apparatus.

In other embodiments, as shown in FIG. 1 to FIG. 5, the first driven slide door member 9 is provided with a fixation panel 95 for connecting the door panel 3. The driving slide door member 1 is separated from the fixation panel 95, that is, only the first driven slide door member 9 is connected to the door panel 3 at this time, so that the driving slide door member 1 indirectly drives the door panel 3 to move in the width direction of the box door 2 through the first driven slide door member 9.

The driving slide door member 1, which directly withstands the driving force, does not withstand the weight of the door panel 3, while the first driven slide door member 9 connected to the door panel 3 withstands the weight of the entire door panel 3. This prevents the driving slide door member 1 from being subjected to external forces in other directions during the process of opening or closing the box door 2, and reduces the problem of the door panel 3 swaying when moving relative to the box door 2.

In this embodiment, since the driving slide door member 1 does not withstand the weight of the door panel 3, it can focus more on providing smooth driving force, avoiding interference from the weight of the door panel 3 or external forces in other directions. In addition, the first driven slide door member 9 independently withstands the weight of the door panel 3, which can be more conveniently adjusted according to the actual weight and movement of the door panel 3, thereby effectively reducing the swaying of the door panel 3 during movement.

In an embodiment of the present application, there is provided a door body assembly, as shown in FIG. 1 to FIG. 3, including a box door 2, a door panel 3, and a slide door apparatus. The box door 2 is rotatably connected to the box body 4, and the box door 2 is configured to open or close a storage space of the box body 4. The door panel 3 is slidably provided at the outer side of the box door 2. As for the structure of the slide door apparatus, reference may be made to the above embodiments and it will not be described in detail here.

In the door body assembly according to this embodiment, the box body 4 drives the driving slide door member 1 through the traction member 17 during the process of opening or closing the box door 2. The driving slide door member 1 drives the first driven slide door member 9 to move the door panel 3 in a width direction of the box door 2 through the first driven slide door member 9, thereby avoiding interference between the door panel 3 and external obstacles. During this process, the driving slide door member 1 that directly withstands the driving force may not withstand the weight of the door panel 3 according to specific settings, while the first driven slide door member 9 connected to the door panel 3 withstands the weight of the entire door panel 3, so that it may prevent the driving slide door member 1 from being subjected to external forces in other directions during the process of opening or closing the box door 2.

In the door body assembly according to the embodiment, by providing the slide door apparatus which includes a traction member 17, a driving slide door member 1, and a first driven slide door member 9 at a box door 2, the driving slide door member 1 is in transmission connection with a box body 4 through the traction member 17, and the first driven slide door member 9 is in transmission connection with the driving slide door member 1, so that the box body 4 drives the driving slide door member 1 through the traction member 17, and the driving slide door member 1 drives the first driven slide door member 9 to drive a door panel 3 to move in a width direction of the box door 2 through the first driven slide door member 9. This allows the door panel 3 to avoid obstacles on two sides, solving the problem of interference during door opening.

In some embodiments, as shown in FIG. 1 to FIG. 3, the slide door apparatus is provided at a top end of the box door 2, and the door body assembly further includes a second driven slide door member 18 provided at a bottom end of the box door 2 and connected to the door panel 3. During the process of opening or closing the box door 2, the second driven slide door member 18 is matched with the first driven slide door member 9 to guide the door panel 3 to move in the width direction of the box door 2.

In this embodiment, the traction member 17, the driving slide door member 1, and the first driven slide door member 9 are provided at the top end of the box door 2. The second driven slide door member 18 is provided at the bottom end of the box door 2. During the process of opening or closing the box door 2, the box body 4 drives the driving slide door member 1 through traction member 17. The driving slide door member 1 drives the first driven slide door member 9 to move the door panel 3 in the width direction of the box door 2 through the first driven slide door member 9, thereby avoiding interference between the door panel 3 and external obstacles. During this process, the second driven slide door member 18 is matched with the first driven slide door member 9 to guide the door panel 3 to move in the width direction of the box door 2, effectively improving the stability during movement.

In this embodiment, the driving slide door member 1, the first driven slide door member 9, and the second driven slide door member 18 work together to effectively restrict the movement direction of the door panel 3. This ensures that door panel 3 moves along a predetermined trajectory during the sliding process, avoiding swaying and instability caused by directional deviation. This limiting effect ensures the stability of the door panel 3.

For the convenience of mounting the slide door apparatus, the top end of the box door 2 is provided with a first end cover 21, which is provided with a mounting slot for mounting the traction member 17, the driving slide door member 1, and the first driven slide door member 9. According to the specific shapes of the traction member 17, the driving slide door member 1, and the first driven slide door member 9, the position and shape of the mounting slot may be adjusted to meet different mounting requirements. Similarly, the bottom end of the box door 2 is provided with a second end cover 22, which is provided with a mounting slot for placing the second driven slide door member 18. According to the shape of the second driven slide door member 18 and the position where the door panel 3 needs to be connected, the position and shape of the mounting slot can be adjusted to meet different mounting requirements.

In an embodiment, as shown in FIG. 7, the second driven slide door member 18 is of a C-shaped drawer track structure, including a third pedestal 181 and a fourth slider 182. The third pedestal 181 is provided with a fourth guide rail 1811 inside and connected to the door panel 3. The fourth slider 182 is slidably provided at (generally internally connected to) the fourth guide rail 1811 and connected to the box door 2. The second hanger 183 is connected to the outer side of the third pedestal 181 and configured to hang the door panel 3.

In this embodiment, the inner side of the third pedestal 181 is provided with the fourth guide rail 1811, and the fourth slider 182 is connected to the box door 2. The outer side of the third pedestal 181 is connected to the door panel 3 through the second hanger 183. When the door panel 3 moves relative to the box door 2, the third pedestal 181 moves relative to the fourth slider 182 through the fourth guide rail 1811, thereby matched to guide the movement of the door panel 3 and the box door 2.

In an embodiment, as shown in FIG. 7, the second driven slide door member 18 further includes a second hanger 183. The second hanger 183 is connected to an outer side of the third pedestal 181 and configured to hang the door panel 3.

In this embodiment, the second hanger 183, like the first hanger 94, also serves as a hanging point for the door panel 3, making the mounting of the door panel 3 simpler and faster. Installers only need to hang the door panel 3 to the first hanger 94 and the second hanger 183, without the need for complex fixation or connecting operations.

During the mounting process, installers first firmly connect the first hanger 94 and the second hanger 183 to the outside of the second pedestal 91 and the outside of the third pedestal 181. Then, they hang or connect the corresponding part of the door panel 3 to the first hanger 94 and the second hanger 183. Due to the firm connection between the first hanger 94 and the second pedestal 91, as well as the firm connection between the second hanger 183 and the third pedestal 181, the door panel 3 also maintains a stable connection state through the first hanger 94 and the second hanger 183.

Similarly, the second driven slide door member 18 further includes a second ball bearing support 184. The second ball bearing support 184 is slidably connected to the fourth guide rail 1811, and the fourth slider 182 is slidably connected to the second ball bearing support 184. The fourth slider 182 slides with low friction and high efficiency in the fourth guide rail 1811 with the assistance of the second ball bearing support 184. Due to the presence of the second ball bearing support 184, the sliding process of the fourth slider 182 becomes smoother and more reliable, ensuring the stable operation of the entire second driven slide door member 18. It should be noted that the specific structure of the second ball bearing support 184 is the same as that of the first ball bearing support 93, and will not be described in detail here.

It should be noted that in practical applications, the design of the first slider 11, the second slider 12, the third slider 92, and the fourth slider 182 can be flexible and varied to adapt to different working scenarios and performance requirements. They are not limited to specific shapes, sizes, or materials, but can be customized and optimized according to specific needs.

From a material perspective, the first slider 11, the second slider 12, the third slider 92, and the fourth slider 182 can be made of materials with high wear resistance, low friction coefficient, and good stability, such as metal alloys, engineering plastics, or special lubricants. These materials are selected to improve the durability of the sliders, reduce wear and noise during sliding, and ensure smooth sliding.

In terms of structural design, the first slider 11, the second slider 12, the third slider 92, and the fourth slider 182 can employ various guide rail contact surfaces, such as planar contact, ball contact, or sliding bearing contact. These different contact methods each have their advantages and disadvantages. For example, ball contact reduces friction and wear, but the cost is relatively high. While flat contact offers a simpler structure but may require more frequent lubrication and maintenance. Therefore, when choosing a suitable contact method, factors such as usage conditions, cost-effectiveness, and ease of maintenance should be comprehensively considered.

In another embodiment of the present application, as shown in FIG. 1 to FIG. 9, there is provided a refrigeration equipment, including a box body 4 and a door body assembly as provided in any of the above embodiments. Herein, the box body 4 is provided with a storage space, and the box door 2 is rotatably connected to the box body 4 and configured to open or close the storage space. As for the structure of the door body assembly, reference may be made to the above embodiments and it will not be described in detail here.

By providing the door panel 3 at the box door 2, when the refrigeration equipment is embedded and located in a groove-shaped space, or when it is located between two cabinets, the door panel 3 can be located flush with the cabinets on the side walls or two sides of the groove to reduce the gap between the refrigeration equipment and the adjacent walls or cabinets, making it more aesthetically pleasing.

Meanwhile, when the box door 2 rotates, the driving slide door member 1 may drive the door panel 3 to move relative to the box door 2 during the rotation of the box door 2, to stay as far away as possible from obstacles such as the wall or cabinet of the side door of the box body 4, thereby preventing these obstacles from blocking the door panel 3 and affecting the rotation of the box door 2, resulting in the box door 2 being unable to open or close normally.

By the combination of the box door 2 and the door panel 3, the refrigeration equipment may avoid interference with the door panel and surrounding objects during opening and closing, greatly improving user convenience. This design advantage is particularly evident in confined kitchen environments. In addition, by providing the slider and guide rail inside the driving slide door member 1, the door panel 3 may move smoothly during the opening and closing process, improving the service life and stability of the refrigerator.

It can be understood that if the door body assembly has the beneficial effects of the above embodiments, the refrigeration equipment will correspondingly have the beneficial effects of the above embodiments. As for its specific implementation, reference can be made to the above embodiments, and it will not be described in detail here.

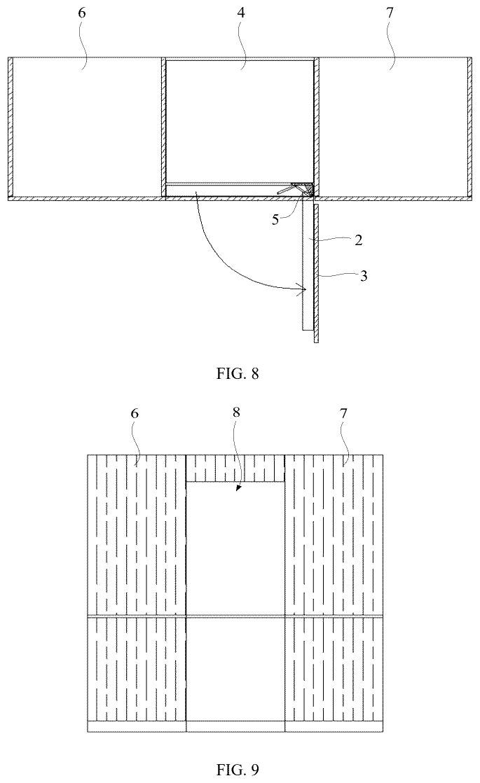

In some embodiments, as shown in FIG. 8 and FIG. 9, the door body assembly and the box body 4 are located within the mounting space 8 formed between a first cabinet 6 and a second cabinet 7. The outer side of the mounting space 8 is provided with an opening, which allows the door body assembly and the box body 4 to be integrated into the cabinet. When the box door 2 passes through the opening to control the opening or closing of the storage space, the driving slide door member 1 is configured to drive the door panel 3 at the box door 2 to move a predetermined distance away from or toward the hinge 5, so that the door panel 3 avoids the side walls of the first cabinet 6 and the second cabinet 7.

When the box door 2 passes through the opening to control the opening or closing of the storage space, the driving slide door member 1 is configured to drive the door panel 3 at the box door 2 to move a predetermined distance away from or toward the hinge 5. To avoid interference between the door panel 3 and the side walls of the first cabinet 6 and the second cabinet 7, the door panel 3 may be smoothly opened or closed through a predetermined distance of movement, without colliding or jamming with the side walls of the cabinets.

For example, as shown in FIG. 8 and FIG. 9, during the process of opening the box door 2, the driving slide door member 1 drives the door panel 3 to move a predetermined distance along the box door 2 in a direction away from the hinge 5. In this way, the door panel 3 can smoothly avoid the side wall of the second cabinet 7, allowing the box door 2 to be fully opened, making it convenient for users to store and retrieve items.

Similarly, during the process of closing the box door 2, the driving slide door member 1 drives the door panel 3 to move a predetermined distance along the box door 2 in a direction towards the hinge 5. In this way, the door panel 3 can smoothly avoid the side wall of the first cabinet 6, allowing the box door 2 to be completely closed, maintaining overall aesthetics and sealing.

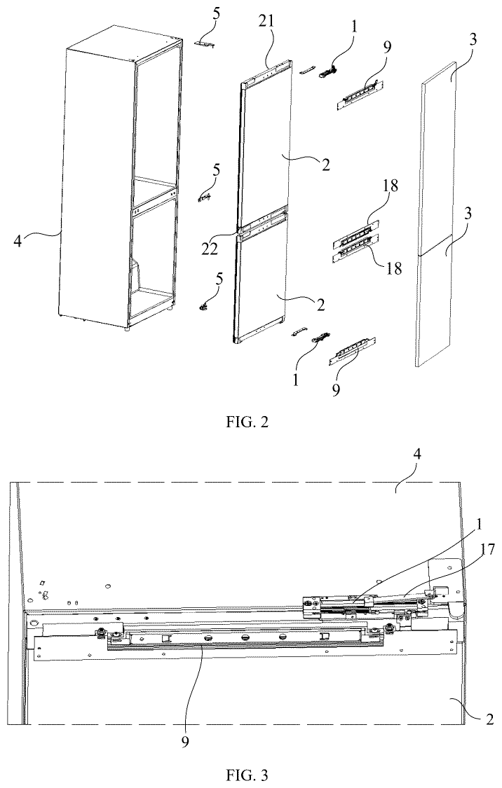

In some embodiments, as shown in FIG. 1 and FIG. 2, the box body 4 is provided with at least two storage spaces, and a plurality of door body assemblies are provided, each door body assembly corresponding to one of the storage spaces, to drive the door panel 3 to move relative to the corresponding box door 2 during the process of opening or closing any of the box door 2.

In the present application, the box body 4 has at least two storage spaces, which can be set to different storage environments (different temperatures, humidity, and the like) to meet the storage conditions of different items. Each storage space is provided with a corresponding door body assembly, and the box door 2 of the corresponding door body assembly can open or close the corresponding storage space, allowing the two storage spaces to be independently opened or closed, facilitating users to store or retrieve items from the storage space. The door panel 3 of each door body assembly can also slide relative to the corresponding box door 2. When the box door 2 is closed, the door panel 3 can be flush with the cabinet on the side, or when the box door 2 is opened, the door panel 3 can avoid obstacles on two sides.

In an embodiment, the box body 4 is provided with a first storage space and a second storage space. Correspondingly, the door body assembly also includes a first door body assembly and a second door body assembly. The box door 2 of the first door body assembly is rotatably connected to the box body 4 to open or close the first storage space, and the box door 2 of the second door body assembly is rotatably connected to the box body 4 to open or close the second storage space.

Furthermore, the first door body assembly and the second door body assembly are provided vertically along a height direction of the box door 2. The first door body assembly is provided with the driving slide door member 1, the first driven slide door member 9, and the second driven slide door member 18. The corresponding driving slide door member 1, the first driven slide door member 9, and the second driven slide door member 18 can be used to control the movement of the corresponding door panel 3 and the box door 2. The second door body assembly is provided with the driving slide door member 1, the first driven slide door member 9, and the second driven slide door member 18. The corresponding driving slide door member 1, the first driven slide door member 9, and the second driven slide door member 18 can be used to control the movement of the corresponding door panel 3 and the box door 2.

Finally, it should be noted that the above embodiments are only used to illustrate the present application, but not to limit the present application. Although the application has been described in detail with reference to the embodiments, those skilled in the art should understand that various combinations, modifications, or equivalent replacements of the solutions of the application do not depart from the scope of the solutions of the application, and should all be included in the scope of the claims of this application.

1. A slide door apparatus for a refrigeration equipment comprising a box body, a box door rotatably connected to the box body and configured to open or close a storage space of the box body and a door panel slidably provided outside the box door,
wherein the slide door apparatus comprises:
a traction member;
a driving slide door member provided at the box door wherein the driving slide door member is in transmission connection with the box body through the traction member; and
a first driven slide door member provided at the box door, wherein the first driven slide door member is in transmission connection with the driving slide door member, and at least one of the first driven slide door member or the driving slide door member is connected to the door panel,
wherein during the process of opening or closing the box door, the box body drives the driving slide door member through the traction member, and the driving slide door member drives the first driven slide door member to drive the door panel to move in a width direction of the box door through the first driven slide door member matched with the driving slide door member.

2. The slide door apparatus of claim 1, wherein the driving slide door member comprises:
a first pedestal wherein a first side of the first pedestal is provided with a first guide rail and a second side of the first pedestal is provided with a second guide rail.
a first slider slidably provided at the first guide rail and connected to the box body through the traction member;
a second slider slidably provided at the second guide rail and in transmission connection with the first driven slide door member; and
a flexible cable, wherein two ends of the flexible cable are connected to the first slider and the second slider, respectively,
wherein in a case that the box body drives the first slider to move on the first guide rail through the traction member, the first slider drives the second slider to move on the second guide rail in an opposite direction through the flexible cable.

3. The slide door apparatus of claim 2, wherein the flexible cable comprises:
a first flexible cable, wherein the first flexible cable bypasses a first end of the first pedestal, and two ends of the first flexible cable are connected to a first end of the first slider and a first end of the second slider, respectively; and
a second flexible cable, wherein the second flexible cable bypasses a second end of the first pedestal, and two ends of the second flexible cable are connected to a second end of the first slider and a second end of the second slider, respectively.

4. The slide door apparatus of claim 2, wherein the first driven slide door member comprises:
a second pedestal wherein an inner side of the second pedestal is connected to the second slider, an outer side of the second pedestal is connected to the door panel and the second pedestal is provided with a third guide rail; and
a third slider slidably provided at the third guide rail and connected to the box door,
wherein in a case that the second slider moves on the second guide rail, the second slider (drives the second pedestal to move relative to the third slider through the third guide rail.

5. The slide door apparatus of claim 4, wherein the first driven slide door member further comprises:
a first ball bearing support, wherein the first ball bearing support is slidably connected to the third guide rail, and the third slider is slidably connected to the first ball bearing support.

6. The slide door apparatus of claim 5, wherein the first ball bearing support comprises:
a support frame provided between the third guide rail and the third slider and provided with a limit notch; and
a ball bearing roll-ably provided at the limit notch, wherein a first side of the ball bearing abuts against the third guide rail, and a second side of the ball bearing passes through the limit notch and abuts against the third slider.

7. The slide door apparatus of claim 4, wherein the third guide rail is provided with a limit member located at two sides of the third slider respectively; and wherein, in a case that the third slider moves within the third guide rail, the movement range of the third slider is limited by a contact between the limit member and the third slider.

8. The slide door apparatus of claim 4, wherein the first driven slide door member further comprises:
a first hanger connected to the outer side of the second pedestal and configured to hang the door panel.

9. The slide door apparatus of claim 1, wherein the first driven slide door member is provided with a fixation panel for connecting the door panel, and the driving slide door member is connected to the fixation panel to allow the first driven slide door member and the driving slide door member simultaneously drive the door panel to move in the width direction of the box door.

10. The slide door apparatus of claim 1, wherein the first driven slide door member is provided with a fixation panel for connecting the door panel, and the driving slide door member is separated from the fixation panel to allow the driving slide door member indirectly drive the door panel to move in the width direction of the box door through the first driven slide door member.

11. A door body assembly comprising:
a box door rotatably connected to a box body and configured to open or close a storage space of the box body;
a door panel slidably provided at the outer side of the box door; and
the slide door apparatus of any claim 1, wherein the slide door apparatus is provided at the box door.

12. The door body assembly of claim 11, wherein the slide door apparatus is provided at a top end of the box door, and the door body assembly further comprises a second driven slide door member provided at a bottom end of the box door and connected to the door panel, and wherein during the process of opening or closing the box door, the second driven slide door member is matched with the first driven slide door member to guide the door panel to move in the width direction of the box door.

13. The door body assembly of claim 12, wherein the second driven slide door member comprises:
a third pedestal provided with a fourth guide rail and connected to the door panel; and
a fourth slider slidably provided at the fourth guide rail and connected to the box door.

14. The door body assembly of claim 13, wherein the second driven slide door member further comprises:
a second hanger connected to an outer side of the third pedestal and configured to hang the door panel.

15. A refrigeration equipment, comprising:
a box body provided with a storage space;
the door body assembly of claim 11, wherein the box door is rotatably connected to the box body and configured to open or close the storage space.

16. The refrigeration equipment of claim 15, wherein the box body is provided with at least two storage spaces, and a plurality of door body assemblies are provided, each door body assembly corresponding to one of the storage spaces, to drive the door panel to move relative to the corresponding box door during the process of opening or closing any of the box doors.

17. The refrigeration equipment of claim 16, wherein the box body is provided with a first storage space and a second storage space, and two door body assemblies are provided, namely a first door body assembly and a second door body assembly, and
wherein the box door of the first door body assembly is rotatably connected to the box body and is configured to open or close the first storage space, and the box door of the second door body assembly is rotatably connected to the box body and is configured to open or close the second storage space.
